(19) United States
(12) Patent Application Publication
(10) Pub. No.: US 2008/0159214 A1
(43) Pub. Date: Jul. 3, 2008

(54) Apparatus

(75) Inventors: Kari Majonen, Haukipudas (FI); Ulo Parts, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/895,791

(22) Filed: Aug. 27, 2007

(30) Foreign Application Priority Data
Dec. 29, 2006 (GB) GB 0626022.8

(51) Int. Cl. H04Q 7/20; H04Q 7/00

(52) U.S. Cl. 370/329; 455/452.2

(57) ABSTRACT

An apparatus including a data processing entity configured to estimate at least one group quality value of a first set of at least one group of sub-carriers and to estimate the at least one group quality value of a second set of at least one group of sub-carriers, wherein the second set is selected from the first set dependent on the estimates of the at least one group quality value of the first set.

### CROSS-REFERENCE TO RELATED APPLICATIONS

This patent application claims priority under 35 U.S.C. §119(a) from a UK Patent Application no. GB 0626022.8, filed Dec. 29, 2006, the disclosure of which is incorporated by reference herein in its entirety.

### TECHNICAL FIELD

The teachings in accordance with the exemplary embodiments of this invention relate generally to an apparatus, and in particular to apparatus for providing a service in a communication system.

### BACKGROUND

A communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various service applications.

A communication system is a facility which facilitates the communication between two or more entities such as the communication devices, network entities and other nodes. A communication system may be provided by one more interconnect networks. One or more gateway nodes may be provided for interconnecting various networks of the system. For example, a gateway node is typically provided between an access network and other communication networks, for example a core network and/or a data network.

An appropriate access system allows the communication device to access to the wider communication system. An access to the wider communications system may be provided by means of a fixed line or wireless communication interface, or a combination of these. Communication systems providing wireless access typically enable at least some mobility for the users thereof. Examples of these include wireless communications systems where the access is provided by means of an arrangement of cellular access networks. Other examples of wireless access technologies include different wireless local area networks (WLANs) and satellite based communication systems.

A wireless access system typically operates in accordance with a wireless standard and/or with a set of specifications which set out what the various elements of the system are permitted to do and how that should be achieved. For example, the standard or specification may define if the user, or more precisely user equipment, is provided with a circuit switched bearer or a packet switched bearer, or both. Communication protocols and/or parameters which should be used for the connection are also typically defined. For example, the manner in which communication should be implemented between the user equipment and the elements of the networks and their functions and responsibilities are typically defined by a predefined communication protocol.

In the cellular systems a network entity in the form of a base station provides a node for communication with mobile devices in one or more cells or sectors. It is noted that in certain systems a base station is called ‘Node B’. Typically the operation of a base station apparatus and other apparatus of an access system required for the communication is controlled by a particular control entity. The control entity is typically interconnected with other control entities of the particular communication network. Examples of cellular access systems include Universal Terrestrial Radio Access Networks (UTRAN) and GSM (Global System for Mobile) EDGE (Enhanced Data for GSM Evolution) Radio Access Networks (GERAN).

A non-limiting example of another type of access architectures is a concept known as the Evolved Universal Terrestrial Radio Access (E-UTRA). An Evolved Universal Terrestrial Radio Access Network (E-UTRAN) consists of E-UTRAN Node Bs (eNBs) which are configured to provide base station and control functionalities of the radio access network. The eNBs may provide E-UTRA features such as user plane radio link control/medium access control/physical layer protocol (RLC/MAC/PHY) and control plane radio resource control (RRC) protocol terminations towards the mobile devices.

In a system providing packet switched connections the access networks are connected to a packet switched core network via appropriate gateways. For example, the eNBs are connected to a packet data core network via an E-UTRAN access gateway (aGW).

Control of the downlink of the E-UTRAN from the base station to the user equipment is carried out based on several factors. One of these factors is the channel quality indicator (CQI) measured at the user equipment and transmitted to the base station (BS). In particular the CQI information is required as a feedback from UE to base station (BS) so that the BS can allocate users to different parts of the available bandwidth with suitable transmission parameters (e.g. modulation and coding) in an efficient manner. Downlink scheduling may also depend on system load and delay sensitivity of certain transmissions

According to current parameter setting in E-UTRAN standards the available bandwidth is divided into reporting blocks. Each reporting block is further divided into 2 physical resource blocks (PRBs). Each resource block comprises 12 adjacent sub-carriers. Each sub-carrier is 15 kHz from the adjacent sub-carrier. Thus current specifications require that each physical resource block has a bandwidth of 12*15 kHz=180 kHz and each reporting block has a bandwidth of 2 PRBs=2*12*1 5 kHz=360 kHz.

According to current proposed standards the UE should estimate CQI parameters for each of the reporting blocks and report at least some of the reporting block CQI parameters so that the BS can then schedule different users to different RBs in order that the whole bandwidth is used as optimally as possible. However, as the total bandwidth can vary from 1.25 to 20 MHz in E-UTRAN, the total number of reporting blocks for which the CQI information should be fed back varies accordingly from 3 to 50.

In the case where CQI information is transmitted for each of the 50 reporting blocks using 5 bits per CQI, the bandwidth required for transmitting this information would be 500 kbit/s. Further error protection would increase this required bandwidth.

Furthermore, the current requirements for estimating CQI for each resource block is problematic. One typical method measures the signals for each sub-carrier of each resource block and then calculates a CQI value for each sub-carrier. These CQI values are then averaged across the block and an average CQI value created. This process requires a significant number of sub-carriers to be monitored and the calculation of a CQI value for each sub-carrier and then an average CQI across all of the sub-carriers requires significant power and processor resources.

A second known method would be to measure CQI only for one sub-carrier and use this measurement for the whole reporting block. This approach although consuming less power and processor produces systematically noisy estimates.

### SUMMARY

In an exemplary aspect of the invention, there is provided an apparatus comprising a data processing entity configured to estimate at least one group quality value of a first set of at least one group of sub-carriers and to estimate the at least one group quality value of a second set of at least one group of sub-carriers, wherein the second set is selected from the first set dependent on the estimates of the at least one group quality value of the first set.

In another exemplary aspect of the invention, there is provided a method, comprising estimating at least one group quality value of a first set of at least one group of sub-carriers for a communications link, selecting a second set of at least one group of sub-carriers from the first set dependent on the estimates of the at least one group quality value of the first set, and estimating the at least one group quality value of the second set of at least one group of sub-carriers.

In another exemplary aspect of the invention, there is provided a computer program product embodied on a computer readable memory and configured to perform actions when the program is executed by a data processing entity for estimating quality over a communications link, the actions comprising estimating at least one group quality value of a first set of at least one group of sub-carriers, selecting a second set of at least one group of sub-carriers from the first set dependent on the estimates of the at least one group quality value of the first set, and estimating the at least one group quality value of the second set of at least one group of sub-carriers.

In another exemplary aspect of the invention, there is provided an apparatus comprising means for estimating at least one group quality value of a first set of at least one group of sub-carriers, means for estimating the at least one group quality value of a second set of at least one group of sub-carriers, and means for selecting the second set from the first set dependent on the estimates of the at least one group quality value of the first set.

In yet another exemplary aspect of the invention, there is a circuit comprising a receiver configured to receive a signal from at least one antenna, the signal received via at least one channel, and an estimator configured to estimate at least one group quality value of a first set of at least one group of sub-carriers, and to estimate at least one group quality value of the second set of at least one group of sub-carriers; and a selector configured to select a second set of at least one group of sub-carriers from the first set dependent on the estimates of the at least one group quality value of the first set.

### BRIEF DESCRIPTION OF THE DRAWINGS

For a better understanding of the present invention and how the same may be carried into effect, reference will now be made by way of example only to the accompanying drawings in which:

FIG. 1 shows a schematic presentation of a communication architecture wherein the invention may be embodied; FIG. 2 shows a partially sectioned view of a mobile device;

FIG. 2 shows a partially sectioned view of a mobile device; and

FIG. 3 show a flow chart in accordance with a specific embodiment of the present invention.

FIG. 4 illustrates a method in accordance with an exemplary embodiment of the invention.

### DETAILED DESCRIPTION

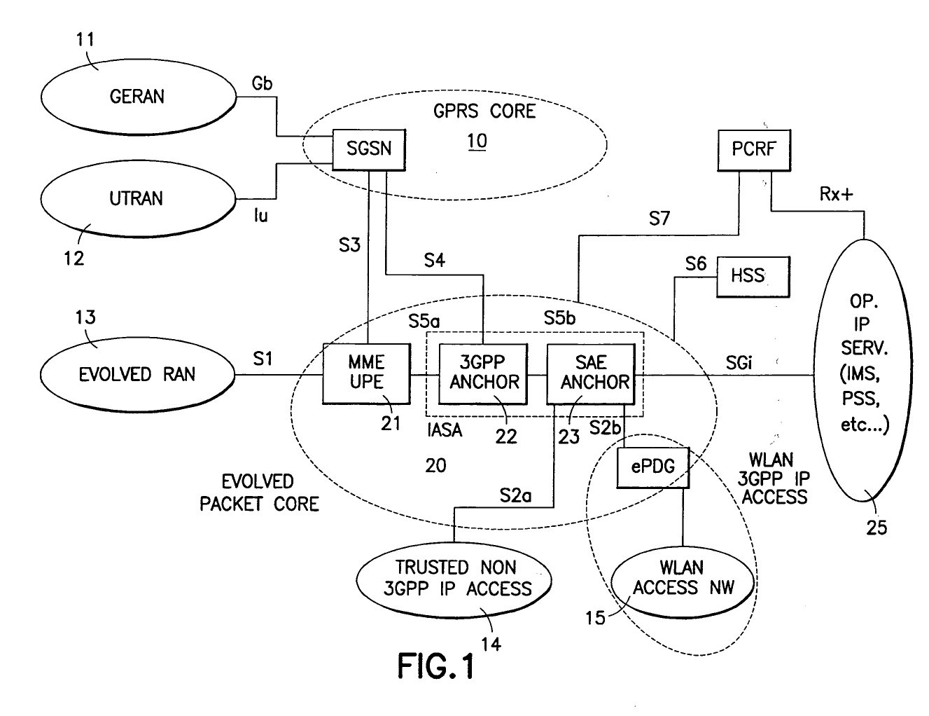

In the following certain specific embodiments are explained with reference to standards such as Global System for Mobile (GSM) Phase 2, Code Division Multiple Access (CDMA) Universal Mobile Telecommunication System (UMTS) and long-term evolution (LTE). The standards may or not belong to a concept known as the system architecture evolution (SAE) architecture, the overall architecture thereof being shown in FIG. 1.

More particularly, FIG. 1 shows an example of how second generation (2G) access networks, third generation (3G) access networks and future access networks, referred to herein as long-term evolution (LTE) access networks are attached to a single data anchor (3GPP anchor). The anchor is used to anchor user data from 3GPP and non-3GPP networks. This enables adaptation of the herein described mechanism not only for all 3GPP network access but as well for non-3GPP networks.

In FIG. 1 two different types of radio access networks 11 and 12 are connected to a general packet radio service (GPRS) core network 10. The access network 11 is provided by a GERAN system and the access network 12 is provided by a UMTS terrestrial radio access (UTRAN) system. The core network 10 is further connected to a packet data system 20.

An evolved radio access system 13 is also shown to be connected to the packet data system 20. Access system 13 may be provided, for example, based on architecture that is known from the E-UTRA and base on use of the E-UTRAN Node Bs (eNodeBs or eNBs).

Access system 11, 12 and 13 may be connected to a mobile management entity 21 of the packet data system 20. These systems may also be connected to a 3GPP anchor node 22 which connects them further to a SAE anchor 23.

FIG. 1 shows further two access systems, that is a trusted non-3Gpp IP (internet protocol) access system 14 and a WLAN access system 15. These are connected directly to the SAE anchor 23.

In FIG. 1 the service providers are connected to a service provider network system 25 connected to the anchor node system. The services may be provided in various manners, for example based on IP multimedia subsystem and so forth. These do not form a part of the invention, and therefore are not explained in any detail other than that different service applications may set different requirements for the connection provided to the user devices.

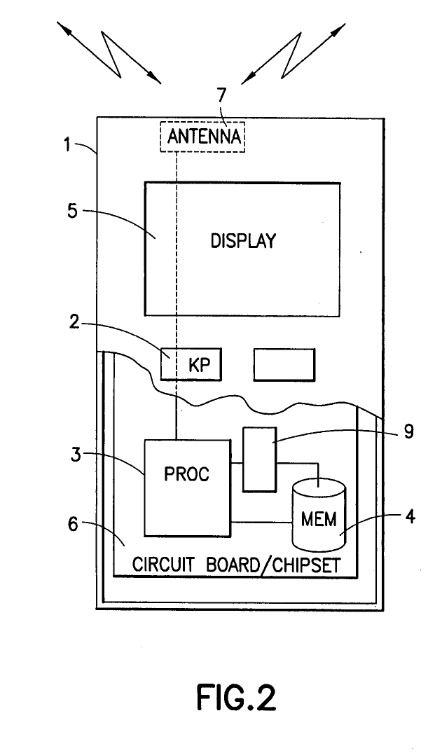

FIG. 2 shows a schematic partially sectioned view of a possible user device, and more particularly of a mobile device 1 that can be used for accessing a communication system via a wireless interface provided via at least one of the access systems of FIG. 1. The mobile device of FIG. 2 can be used for various tasks such as making and receiving phone calls, for receiving and sending data from and to a data network and for experiencing, for example, multimedia or other content. An appropriate mobile device may be provided by any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The mobile device may communicate via an appropriate radio interface arrangement of the mobile device. The interface arrangement may be provided for example by means of a radio part 7 and associated antenna arrangement. The antenna arrangement may be arranged internally or externally to the mobile device.

A mobile device is typically provided with at least one data processing entity 3 and at least one memory 4 for use in tasks it is designed to perform. The data processing and storage entities can be provided on an appropriate circuit board and/or in chipsets. This feature is denoted by reference 6.

The user may control the operation of the mobile device by means of a suitable user interface such as key pad 2, voice commands, touch sensitive screen or pad, combinations thereof or the like. A display 5, a speaker and a microphone are also typically provided. Furthermore, a mobile device may comprise appropriate connectors (either wired or wireless) to other devices and/or for connecting external accessories, for example hands-free equipment, thereto.

The mobile device 1 may be enabled to communicate with a number of access nodes, for example when it is located in the coverage areas of the two access system stations 11 and 12 of FIG. 1. This capability is illustrated in FIG. 2 by the two wireless interfaces.

In accordance with an embodiment service information included in a message is used by an access system in service redirection. Service direction may be needed in mobile systems in order to redirect a terminal, for example a mobile device such as user equipment (UE), to a target system or carrier frequency. The purpose of this redirection is efficient usage of network capacity and to improve or keep the quality of the call in acceptable levels. For example, a voice call in a UMTS system may be redirected to a GSM system so enough that UMTS load is available for other connections demanding more resources for the network. Another example is redirection of video streaming in a general packet radio service (GPRS) to the UMTS in order to provide better user experience.

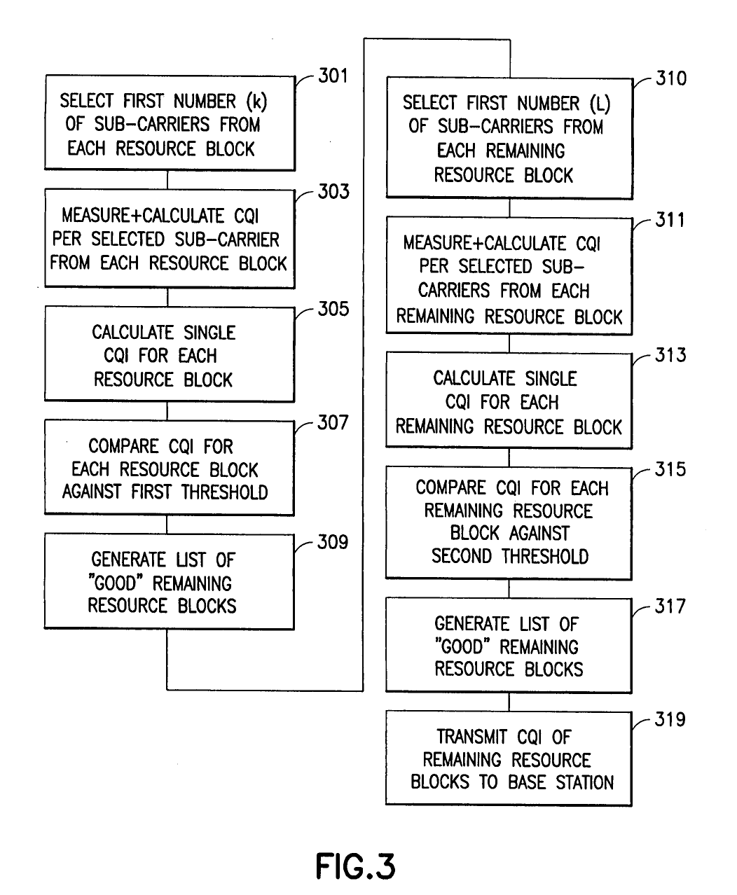

In the following an example is given with reference to FIG. 3 of a CQI estimation and transmission procedure for providing a base station with sufficient feedback about the transmission characteristics of the wireless environment to permit efficient user bandwidth.

In step 301 the mobile device data processing entity 3 selects a first number, k, of the sub-carriers from each of the resource blocks.

In the embodiment described herewith the first number, k, is 1. In other embodiments of the invention the first number, k, may be a number smaller than the total number of sub-carriers in the resource block and is preferably a number between 1 and 5. The first number may be downloaded or pushed from the base station and stored on the mobile device memory 4. The first number may be user defined either directly, where the user selects the number, or indirectly, where the user may select a particular option or variable such as power saving which then selects the first number.

In the embodiment described as an example the selected sub-carrier of the resource block is the central sub-carrier, and the sub-carrier with a frequency as close as half-way between the first and last sub-carrier of the resource block. However the mobile device data processing entity 3, may select any first number of the total number of available sub-carriers in the resource block.

In step 303 the mobile device measures the signals from the central sub-carrier from each of the resource blocks and calculates a CQI value for the central sub-carrier. The calculation of CQI values for sub-carriers is known in the art and will not be described further.

In other embodiments of the present invention where the first number is more than 1, the data processing entity measures the signals from each of the selected k sub-carriers and calculates a CQI value for each of the selected sub-carriers.

In step 305 the mobile device then calculates a single CQI value for each resource block. In this example the single CQI value for each resource block is the same value as calculated for the single central sub-carrier for each resource block.

In the embodiments of the invention where the first number is greater than 1, then in step 305 an averaging process is carried out on the first number of CQI values to produce a single CQI value for each resource block. For example the data processing entity may calculate the mean value of the sub-carrier CQI values. In other embodiments other averaging or weighted averaging processes may be applied.

In step 307 the mobile device data processing entity compares each resource block CQI value against a first threshold value. The threshold value may be downloaded or pushed from the base station and stored on the mobile device memory 4. The threshold value in other embodiments may be user defined either directly, where the user selects the threshold value, or indirectly, where the user may select a particular option or variable such as power saving which then selects the threshold value.

In step 309, the mobile device data processing entity produces a list of resource blocks where the CQI for the resource block is equal to or greater than the threshold value. In other words the data processing entity ‘discards’ the resource blocks with values below the threshold value.

In step 310, the mobile device selects a second number of the sub-carriers of the resource blocks remaining on the list. In the example described herewith the second number is 3, and the three sub-carriers selected are the first and third quartile sub-carriers and the centre sub-carrier.

In other embodiments of the invention the second number of sub carriers is any number of sub-carriers equal to or less than the total number of sub-carriers and greater than the first number of sub-carriers. As described above embodiments of the present invention may use any selection of sub-carriers, however a symmetrical and equal spacing sample of the sub-carriers may be preferred in embodiments as this selection may be expected to provide measurements with less systematic error biases. The second number may be downloaded or pushed from the base station and stored on the mobile device memory 4. The second number may be user defined either directly, where the user selects the number, or indirectly, where the user may select a particular option or variable such as power saving which then selects the second number.

In step 311, the mobile device then measures the selected second number of the sub-carriers of the resource blocks remaining on the list. A CQI value is then calculated for each of the sub-carriers selected within the remaining resource blocks. The selection of new sub-carriers used for CQI estimation (steps 310 and 311) can be done either separately from previous CQI iteration(s) (might result in repeating some calculations) or in incremental fashion so that the different iterations can be combined resulting in better estimates. The latter could be done e.g. so that if there are 5 subcarriers we calculate CQI using subcarrier 3 during the first iteration. The second iteration uses subcarriers 1 and 5, and combined with the first iteration we actually have CQI for subcarriers 1, 3 and 5 (from which we calculate the average). In the next step we would calculate CQI using subcarriers 2 and 4 and combined with the previous iterations we would have estimates for subcarriers 1,2,3,4 and 5.

In step 313, the mobile device then calculates a new CQI value for each of the remaining resource blocks by averaging or weighed averaging the CQI values calculated for each selected second number of sub-carriers in the remaining resource blocks. For example the three CQI values for each remaining resource block are mean averaged in the above example to produce a single CQI value each representing a remaining resource block.

In step 315, each CQI value representing a remaining resource block is compared against a second threshold value. The threshold value may be downloaded or pushed from the base station and stored on the mobile device memory 4. The threshold value in other embodiments may be user defined either directly, where the user selects the threshold value, or indirectly, where the user may select a particular option or variable such as power saving which then selects the threshold value.

In step 317, the mobile device data processing entity 4 edits the list of remaining resource blocks so that any remaining resource block with a CQI value less than the second threshold value is removed or ‘discarded’ from the list.

In step 319 the mobile device transmits to the base station the CQI values for the remaining resource blocks.

As would be appreciated by the person skilled in the art implementations incorporating this invention as shown in the embodiments below, would improve on the previous implementations as the filtering of the resource blocks would mean that only the resource blocks which may be of interest to the base station are reported on. The base station may not be interested in resource blocks with low performance characteristics as the base station would not assign the user these blocks where the signal reaching the mobile device would be poor.

Furthermore in embodiments of the invention the mobile device may focus on making accurate measurements on the resource blocks that provide the best possibility of being candidate resource blocks. Thus only the ‘good’ possible candidates have accurate estimations made and the ‘poor’ candidates discarded after only a small number of estimations.

In some embodiments of the present invention the two stage process, first ‘quick’ CQI estimation using all available resource blocks which is then filtered by a first threshold value, and second ‘detailed’ CQI estimation using selected resource blocks which are further filtered by a second threshold value can be further modified.

In a first further embodiment the two stage process may be improved in situations where reporting bandwidth is limited by adding at least one further stage of a ‘more detailed’ CQI estimation using selected resource blocks from the filtering of the previous stage which are then filtered by a third and further threshold values.

In a second further embodiment the two stage process is improved in situations where the processing power of the user equipment is limited by reducing the process to a single stage. Thus in this stage the method effectively passes from step 309 to 319 bypassing steps 311, 313, 315, 317.

In a further set of embodiments the comparison steps 307, 315 and the ‘discard’ steps 309 and 317 are modified as follows. In steps 307 and 315 the data processing entity compares the CQI value of each resource block or selected resource block against each other to produce an ordered list of each or selected resource blocks.

In step 309 the first n values are selected, where n is a number greater than 1 and less than the number of resource blocks, the remaining resource blocks are discarded from the list. In step 317, the first m values are selected, where m is a number equal to or greater than 1 and less than n.

In this embodiment the reporting block would have a consistent length, equal to m CQI resource block values.

In some embodiments of the invention the selection of sub-carriers used for CQI estimation, as described in steps 310 and 311, may be carried out without using information from the previous selection and measurement steps 301 and 303. In such embodiments the selection and measurement is carried out independent on the selection and measurements carried out in previous iterations.

In other embodiments of the present invention the selection of sub-carriers used in CQI estimation, as described in steps 310 and 311, may be carried out using information from the previous selection and measurement steps 301 and 303. In these embodiments the selection and estimation may be carried out in an incremental fashion so that information from previous iterations can be used with the selection and calculation of the succeeding iterations resulting in the production of more accurate and quicker estimates.

For example if there are 5 sub-carriers per group. A first iteration (steps 301, 303) calculates a CQI using sub-carrier 3. A second iteration (steps 310, 311) uses sub-carriers 1 and 5, but calculates a single CQI (step 313) using the combination of the estimate from the previous iteration and the present iteration—sub-carriers 1, 3 and 5. A further iteration, if required, may further calculate CQIs using subcarriers 2 and 4 and then combine these further estimates with the estimates from previous iteration to produce a CQI estimates from the combination of the estimates of subcarriers 1,2,3,4 and 5.

Although the above examples have been described with respect to resource blocks, the similar methods may be applied to the combination of resource blocks. The terms reporting block and resource block may be interchangeable with respect to this method, the difference being the total number of sub-carriers per division which can be selected from. For example n sub-carriers per reporting block may selected, measured and have their CQI calculated. These may be then averaged to form a CQI value per reporting block and compared against a first threshold to generate a first list of ‘good’ reporting blocks. Then m sub-carriers may be selected from the remaining ‘good’ reporting blocks, measured, and have their CQI calculated. Then the remaining blocks may have a single CQI calculated and be compared against a second threshold to generate a final list of reporting blocks to have their CQI value reported to the base station.

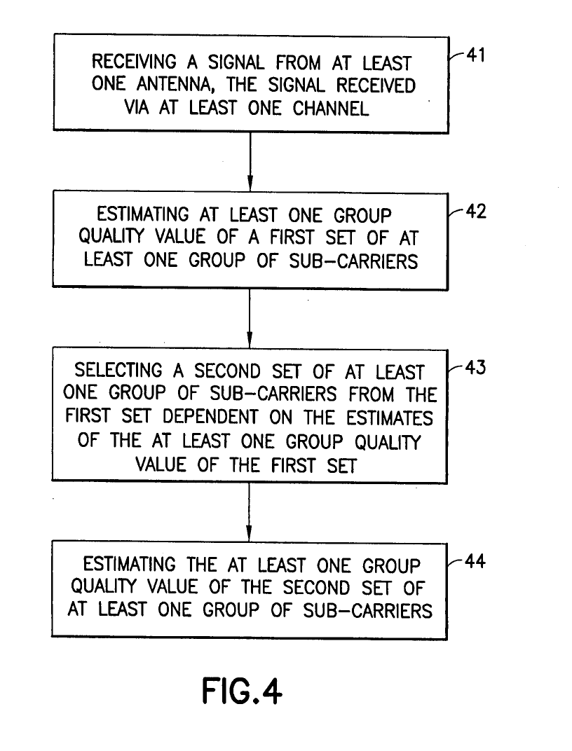

Further, in FIG. 4 there is illustrated an exemplary embodiment of the invention. In FIG. 4 there is presented a method for estimating quality over a communications link comprising receiving a signal from at least one antenna, where the signal is received via at least one channel (Block 41), estimating at least one group quality value of a first set of at least one group of sub-carriers (Block 42), selecting a second set of at least one group of sub-carriers from the first set dependent on the estimates of the at least one group quality value of the first set (Block 43), and estimating the at least one group quality value of the second set of at least one group of sub-carriers (Block 44).

In an exemplary aspect of the present invention there is an apparatus, comprising a data processing entity configured to estimate at least one group quality value of a first set of at least one group of sub-carriers, and to estimate the at least one group quality value of a second set of at least one group of sub-carriers, wherein the second set is selected from the first set dependent on the estimates of the at least one group quality value of the first set.

In addition, in the operation of the apparatus above there may include a second set that is preferably smaller than the first set, a second set that is preferably a sub-set of the first set, and the operation may be preferably configured to report the at least one group quality value of each of the second set of at least one group of sub-carriers to a further apparatus.

Further, the data processing entity embodied in the apparatus above may be configured to include operations of estimating each of the first set at least one group quality value dependent on an estimate of a first number of sub-carriers at least one quality value, estimating each of the second set at least one group quality value dependent on an estimate of a second number of sub-carriers at least one quality value, wherein the second number of sub-carriers may be greater than or equal to the first number of sub-carriers, and/or may comprise each of the first number of sub-carriers.

Further, the data processing entity is preferably configured to estimate each of the second set at least one group quality value dependent on an estimate of a second number of sub-carriers at least one quality value and an estimate of the first number of sub-carriers at least one quality value. In addition, the first set may preferably be the full set of groups, the first number may preferably be one, the second number may preferably be two, and the first set group may include at least one quality value that is preferably a group central sub-carrier quality value, wherein the at least one group quality value is preferably the channel quality indicator (CQI).

Moreover, the data processing entity may be preferably configured to estimate the at least one group quality value of at least one further set of at least one group of sub-carriers, wherein the at least one further set may be selected from a current set dependent on the estimates of the at least one group quality value of the current set, and may preferably be configured to estimate each of the further set of at least one group quality value dependent on the estimated a further number of sub-carriers at least one quality value, wherein the further number of sub-carriers is preferably greater than or equal to the first or second number of sub-carriers.

In the apparatus as described above, the group of sub-carriers may be a reporting block and/or a physical resource block. Furthermore, the apparatus may be embodied on a user equipment, communication system, and/or a base station.

According to the invention there is provided a method for estimating quality over a communications link, comprising estimating at least one group quality value of a first set of at least one group of sub-carriers, selecting a second set of at least one group of sub-carriers from the first set dependent on the estimates of the at least one group quality value of the first set; and estimating the at least one group quality value of the second set of at least one group of sub-carriers.

Further, in the method as described above, the second set may be preferably smaller than the first set and/or the second set may be preferably a sub-set of the first set. In addition, the method may include reporting the at least one group quality value of each of the second set of at least one group of sub-carriers to a further apparatus, estimating each of the first set at least one group quality value may comprise estimating at least one quality value for a first number of sub-carriers, estimating each of the second set at least one group quality value may comprise estimating at least one quality value for a second number of sub-carriers, wherein the second number of sub-carriers may be preferably greater than or equal to the first number of sub-carriers and/or the second number of sub-carriers may comprise each of the first number of sub-carriers.

Furthermore, in the method described above, the estimating of each of the second set at least one group quality value may comprise combining the at least one quality value of the second number of sub-carriers and the at least one quality value of the first number of sub-carriers. In addition, the first set may preferably be the full set of groups, the first number may preferably be one, the second number may preferably be two, in the first set group at least one quality value may preferably be a group central sub-carrier quality value, and the at least one group quality value may preferably be the channel quality indicator (CQI).

The method may further include selecting from a current set of at least one group of sub-carriers a further set of at least one group of sub-carriers dependent on an estimate of the at least one group quality value of the current set, estimating the at least one group quality value of the at least one further set of at least one group of sub-carriers, and/or estimating each of the further set. In addition, the at least one group quality value may comprise estimating at least one quality value of a further number of sub-carriers wherein the further number of sub-carriers is preferably greater than or equal to the first or second number of sub-carriers. Further, in the method described above, the group of sub-carriers may preferably be a reporting block, and/or a physical resource block.

According the invention there is provided a computer program product configured to perform a method for estimating quality over a communications link, comprising estimating at least one group quality value of a first set of at least one group of sub-carriers, selecting a second set of at least one group of sub-carriers from the first set dependent on the estimates of the at least one group quality value of the first set, and estimating the at least one group quality value of the second set of at least one group of sub-carriers.

According to the invention there is provided an apparatus, comprising means for estimating at least one group quality value of a first set of at least one group of sub-carriers, means for estimating the at least one group quality value of a second set of at least one group of sub-carriers; and means for selecting the second set from the first set dependent on the estimates of the at least one group quality value of the first set.

It is noted that whilst embodiments have been described in relation to mobile devices such as mobile terminals, embodiments of the present invention are applicable to any other suitable type of apparatus suitable for communication via access systems. A mobile device may be configured to enable use of different access technologies, for example, based on an appropriate multi-radio implementation.

It is also noted that although certain embodiments were described above by way of example with reference to the exemplifying architectures of certain mobile networks and a wireless local area network, embodiments may be applied to any other suitable forms of communication systems than those illustrated and described herein. It is also noted that the term access system is understood to refer to any access system configured for enabling wireless communication for user accessing applications.

The above described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

It is also noted herein that while the above describes exemplifying embodiments of the invention, there are several variations and modifications which may be made to the disclosed solution without departing from the scope of the present invention.

Furthermore, in an exemplary embodiment of the invention a method may comprise receiving an OFDMA transmission where the channels are subcarriers of the OFDMA transmission. In yet another exemplary embodiment of the invention the method may include receiving TDMA transmission where the channels are time slots of the TDMA transmission.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory 4 may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the exemplary embodiments of this invention could be used to advantage without the corresponding use of other features. As such, the foregoing description should be considered as merely illustrative of the principles of the invention, and not in limitation thereof.

What is claimed is:

1. An apparatus comprising:
a data processing entity configured to estimate at least one group quality value of a first set of at least one group of sub-carriers and to estimate the at least one group quality value of a second set of at least one group of sub-carriers;
wherein the second set is selected from the first set dependent on the estimates of the at least one group quality value of the first set.

2. The apparatus of claim 1, wherein the second set is smaller than the first set.

3. The apparatus of claim 2, wherein the second set is a sub-set of the first set.

4. The apparatus of claim 1, wherein the apparatus is configured to report the at least one group quality value of each of the second set of at least one group of sub-carriers to a further apparatus.

5. The apparatus of claim 1, wherein the data processing entity is configured to estimate each of the at least one group quality value of the first set dependent on an estimate of at least one quality value of a first number of sub-carriers.

6. The apparatus of claim 5, wherein the data processing entity is configured to estimate each of the at least one group quality value of the second set dependent on an estimate of at least one quality value of a second number of sub-carriers.

7. The apparatus of claim 6, wherein the second number of sub-carriers is greater than or equal to the first number of sub-carriers.

8. The apparatus of claim 6, wherein the second number of sub-carriers comprises each of the first number of sub-carriers.

9. The apparatus of claim 6, wherein the data processing entity is configured to estimate each of the at least one group quality value of the second set dependent on the estimate of at least one quality value of a second number of sub-carriers and the estimate of the at least one quality value of the first number of sub-carriers.

10. The apparatus of claim 1, wherein the first set is the full set of groups.

11. The apparatus of claim 5, wherein the first number is one.

12. The apparatus of claim 6, wherein the second number is two.

13. The apparatus of claim 11, wherein the at least one group quality value of the first set is a group central sub-carrier quality value.

14. The apparatus of claim 1 wherein the at least one group quality value of the first set is a channel quality indicator (CQI).

15. The apparatus of claim 1, wherein the data processing entity is further configured to estimate the at least one group quality value of at least one further set of at least one group of sub-carriers, wherein the at least one further set is selected from a current set dependent on the estimates of the at least one group quality value of the current set.

16. The apparatus of claim 15, wherein the data processing entity is configured to estimate each of the at least one group quality value of the at least one further set dependent on at least one estimated quality value of a further number of sub-carriers wherein the further number of sub-carriers is greater than or equal to the first or second number of sub-carriers.

17. The apparatus of claim 1, wherein each of the at least one group of sub-carriers is a reporting block.

18. The apparatus of claim 1, wherein each of the at least one group of sub-carriers is a physical resource block.

19. The apparatus of claim 1 embodied on a user equipment.

20. The apparatus of claim 1 embodied on a base station.

21. The apparatus of claim 1 embodied on a communication system.

22. A method comprising:
estimating at least one group quality value of a first set of at least one group of sub-carriers for a communications link;
selecting a second set of at least one group of sub-carriers from the first set dependent on the estimates of the at least one group quality value of the first set; and
estimating the at least one group quality value of the second set of at least one group of sub-carriers.

23. The method of claim 22, wherein the second set is smaller than the first set.

24. The method of claim 23, wherein the second set is a sub-set of the first set.

25. The method of claim 22, comprising:
reporting the at least one group quality value of each of the second set of at least one group of sub-carriers to a further apparatus.

26. The method of claim 22, wherein estimating each of the first set at least one group quality value comprises estimating at least one quality value for a first number of sub-carriers.

27. The method of claim 26, wherein estimating each of the second set at least one group quality value comprises estimating at least one quality value for a second number of sub-carriers.

28. The method of claim 27, wherein the second number of sub-carriers is greater than or equal to the first number of sub-carriers.

29. The method of claim 27, wherein the second number of sub-carriers comprises each of the first number of sub-carriers.

30. The method of claim 27, wherein estimating each of the second set at least one group quality value comprises combining the at least one quality value of the second number of sub-carriers and the at least one quality value of the first number of sub-carriers.

31. The method of claim 22, wherein the first set is the full set of groups.

32. The method of claim 26, wherein the first number is one.

33. The method of claim 27, wherein the second number is two.

34. The method of claim 32, wherein the at least one quality value of the first set is a group central sub-carrier quality value.

35. The method of claim 22 wherein the at least one group quality value of the first set is a channel quality indicator (CQI).

36. The method of claim 22, further comprising
selecting from a current set of at least one group of sub-carriers a further set of at least one group of sub-carriers dependent on an estimate of the at least one group quality value of the current set;
estimating the at least one group quality value of the at least one further set of at least one group of sub-carriers.

37. The method of claim 36, wherein estimating each of the at least one group quality value of the at least one further set comprises
estimating at least one quality value of a further number of sub-carriers wherein the further number of sub-carriers is greater than or equal to the first or second number of sub-carriers.

38. The method of claim 22, wherein each of the at least one group of sub-carriers is a reporting block.

39. The method of claim 22, wherein each of the at least one group of sub-carriers is a physical resource block.

40. A computer program product embodied on a computer readable memory and configured to perform actions when the program is executed by a data processing entity for estimating quality over a communications link, the actions comprising:
estimating at least one group quality value of a first set of at least one group of sub-carriers;
selecting a second set of at least one group of sub-carriers from the first set dependent on the estimates of the at least one group quality value of the first set; and
estimating the at least one group quality value of the second set of at least one group of sub-carriers.

41. An apparatus comprising:
means for estimating at least one group quality value of a first set of at least one group of sub-carriers;
means for estimating the at least one group quality value of a second set of at least one group of sub-carriers; and
means for selecting the second set from the first set dependent on the estimates of the at least one group quality value of the first set.

42. A circuit comprising:
a receiver configured to receive a signal from at least one antenna, the signal received via at least one channel; and
an estimator configured to estimate at least one group quality value of a first set of at least one group of sub-carriers, and to estimate at least one group quality value of the second set of at least one group of sub-carriers; and
a selector configured to select a second set of at least one group of sub-carriers from the first set dependent on the estimates of the at least one group quality value of the first set.

43. The circuit of claim 42, wherein the second set is smaller than the first set.

44. The circuit of claim 42, comprising:
a reporter configured to report the at least one group quality value of each of the second set of at least one group of sub-carriers to a further circuit.

45. The circuit of claim 42, wherein estimating each of the first set at least one group quality value comprises estimating at least one quality value for a first number of sub-carriers.

46. The circuit of claim 42, wherein the first set is the full set of groups.

47. The circuit of claim 42 wherein the at least one group quality value of the first set is a channel quality indicator (CQI).

48. The circuit of claim 42, further comprising
a selector configured to select from a current set of at least one group of sub-carriers a further set of at least one group of sub-carriers dependent on an estimate of the at least one group quality value of the current set;
an estimator configured to estimate the at least one group quality value of the at least one further set of at least one group of sub-carriers.

49. The circuit of claim 42, wherein each of the at least one group of sub-carriers is a reporting block.

50. The circuit of claim 42, wherein each of the at least one group of sub-carriers is a physical resource block.

51. The circuit of claim 42, embodied in at least one integrated circuit.
